(19) United States
(12) Patent Application Publication
(10) Pub. No.: US 2005/0024471 A1
(43) Pub. Date: Feb. 3, 2005

(54) Transfer Film Cassette

(75) Inventors: Takahiro OKUIE, Nara (JP); Kaoru TSUCHIYA, Osaka (JP); Hirofumi MATSUSHIMA, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Osaka (JP)

(21) Appl. No.: 10/710,551

(22) Filed: Jul. 20, 2004

(30) Foreign Application Priority Data
Jul. 28, 2003 (JP) 2003-280569

(51) Int. Cl. B41J 32/00

(52) U.S. Cl. 347/214; 347/177

(57) ABSTRACT

A transfer film cassette includes a transfer film having a mark on its surface. When the transfer film cassette is attached to a printer, the mark is detected by an optical sensor provided in the printer. Here, a reflecting surface formed at an opposed position to the optical sensor with the transfer film interposed is subjected to a rough surface processing. Thus, a reflectance ratio of the light at the reflecting surface is smaller than that of an evaporated film, a plating film or the like.

### BACKGROUND OF THE INVENTION

1. Field of the Invention

The present invention relates to transfer film cassettes. More specifically, the present invention relates to a transfer film cassette that is applied to a thermal wax transfer printer or a dye-sublimation printer, and houses a transfer film coated with wax or dye and a coating to be transferred to a printing paper.

2. Description of the Prior Art

An example of such kind of a conventional transfer film cassette is disclosed in a Utility Model Laying-open No.5-68650 laid-open on Sep. 17, 1993. According to this prior art, when a light beam is emitted from a light emitting element of a sensor provided in a printer, the light beam is illuminated to a reflecting surface through a transfer film. The light beam reflected by the reflecting surface is incident to a light receiving element of the sensor through the transfer film. When a mark coated on the transfer film is reached to the position interposed between the sensor and the reflecting surface, the light beam is cut off by the mark, and therefore, a detecting manner of the light beam by the sensor is changed. Thus, it is possible to determine a position at which taking-up of the transfer film is suspended.

However, in the prior art, a high reflectance ratio is realized by applying an evaporated film or a plating film to the reflecting surface. Thus, the amount of the reflected light is largely changed due to a slack of the transfer film or a fluctuation of angle of the incident light onto the reflecting surface. As a result, in the prior art, a detected manner of the light by the sensor is changed irrespective of the presence or absence of the mark, and there is a fear of not performing precise positioning.

### SUMMARY OF THE INVENTION

Therefore, it is a primary object of the present invention to provide a transfer film cassette capable of performing precise positioning of the transfer film to be conveyed.

According to claim 1, a transfer film cassette to be attached to a printer provided with an optical sensor, comprises: a transfer film having a mark to be detected by the optical sensor; and a case having a surface which causes a diffuse reflection at an opposed position to the optical sensor with the transfer film interposed when being attached to the printer.

The transfer film has the mark on its surface. The mark is detected by the optical sensor provided in the printer when the transfer film cassette is attached to the printer. Here, a diffuse reflection is formed at a position opposed to the optical sensor with the transfer film interposed. The reflectance ratio of the light at the diffuse reflection is smaller than that of an evaporated film, a plating film or the like. Thus, the change in the amount of the reflected light due to a slack of the transfer film or a fluctuation of angle of the incident light to a rough surface is reduced, and it is possible to perform precise positioning of the transfer film utilizing the mark.

A transfer film cassette of claim 2 is according to claim 1, and the optical sensor detects a light that is reflected by the surface and passed through the transfer film.

A transfer film cassette of claim 3 is according to claim 1, and a front of the mark in a conveying direction of the transfer film is transparent, and the mark is opaque. This makes it possible to clearly identify changes in the amount of the reflected light around a time when the mark is detected.

A transfer film cassette of claim 4 is according to claim 1, and further comprises a take-up spool for taking up the transfer film and a supply spool for supplying the transfer film.

A transfer film cassette of claim 5 is according to claim 1, and the surface is a rough surface.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing one embodiment of the present invention in a disassembled state;

FIG. 2 is a perspective view showing a state where a supply spool and a take-up spool are attached in a housing case;

FIG. 3 is an illustrative view showing one example of a transfer film;

FIG. 4 is a block diagram showing a part of a printer to which FIG. 1 embodiment is attached;

FIG. 5 is an illustrative view showing a state where a light illuminated from a light emitting element is reflected by a rough surface to be incident to a light-receiving element;

FIG. 6 is an illustrative view showing a positional relationship between a mark and the rough surface;

FIG. 7(A) is a graph chart showing one example of an output characteristic of an inverting amplifier provided in a printer;

FIG. 7(B) is a waveform chart showing one example of a clock;

FIG. 7(C) is a waveform chart showing one example of a comparison result output from a comparator of the printer; and

FIG. 7(D) shows a waveform chart showing one example of a puls to be output from a waveform shaping circuit of the printer.

### DETAILED DESCRIPTION OF THE PREFERRED EMBODIMENTS

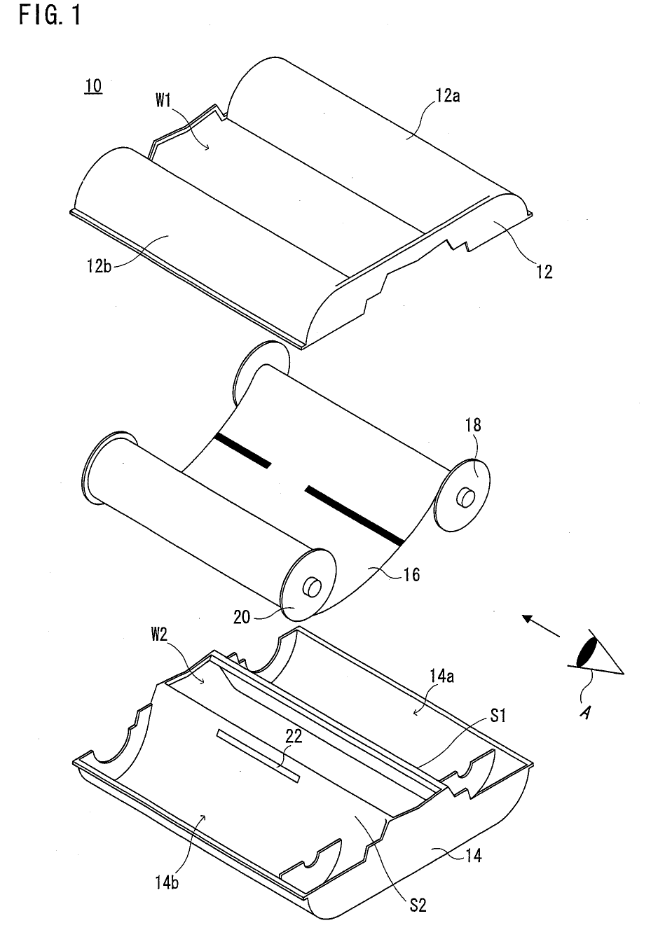

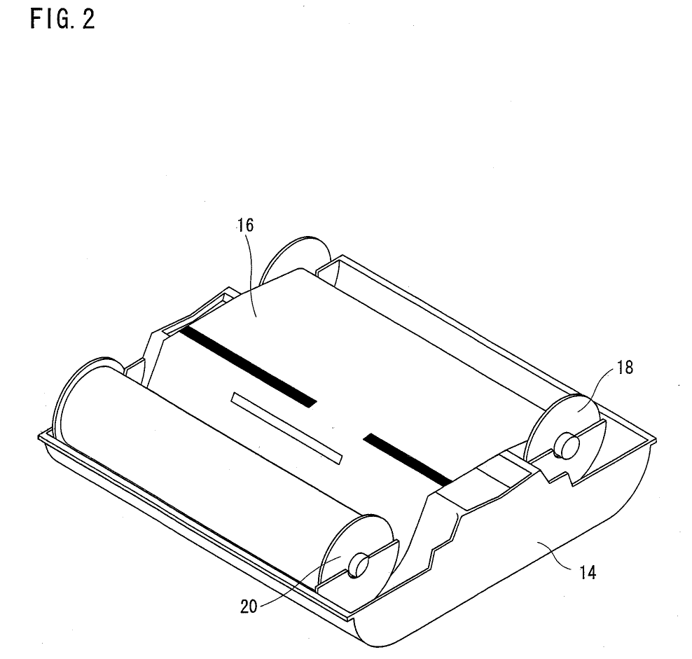

With referring to FIG. 1 and FIG. 2, a transfer film cassette 10 of this embodiment includes a spool cover 12, a housing case 14, a transfer film (ink ribbon) 16, a supply spool (supply bobbin) 18, and a take-up spool (take-up bobbin) 20.

One end of the transfer film 16 in a length direction is fixed at the supply spool 18, and the other end of the transfer film 16 in the length direction is fixed at the take-up spool 20. The transfer film 16 is taken up in the same direction at the supply spool 18 and the take-up spool 20. Accordingly, when rotating the take-up spool 20 in a clockwise direction by rendering a viewpoint A a reference, the transfer film 16 is supplied from the upper side of the supply spool 18 and taken up from the lower side of the take-up spool 20.

The supply spool 18 and the take-up spool 20 are respectively housed in a first housing portion 14a and a second housing portion 14b of the housing case 14, and are respectively covered with a first cover portion 12a and a second cover portion 12b of the roll cover 12. It is noted that a window W1 is formed at the center of the roll cover 12, and a window W2 having approximately the same size as the window W1 is formed at the center of the housing case 14. Accordingly, the transfer film 16 to be being conveyed from the supply spool 18 to the take-up spool 20 is exposed to the outside through the windows W1 and W2.

When the height of a slant S1 adjacent to the window W2 of the first housing portion 14a is compared with the height of a slant S2 adjacent to the window W2 of the second housing portion 14b, the slant S2 is higher than the slant S1. The transfer film 16 supplied from the supply spool 18 is bent at the edge of the slant S2 toward the bottom of the second housing portion 14b. An angle between the slant S2 and the bent transfer film 16 is defined by a diameter of the taken-up transfer film 16. That is, the larger the diameter is, the smaller the angle is. A reflecting surface 22 is formed in periphery to the edge of the slant S2. A description as to the reflecting surface 22 is made in detail later.

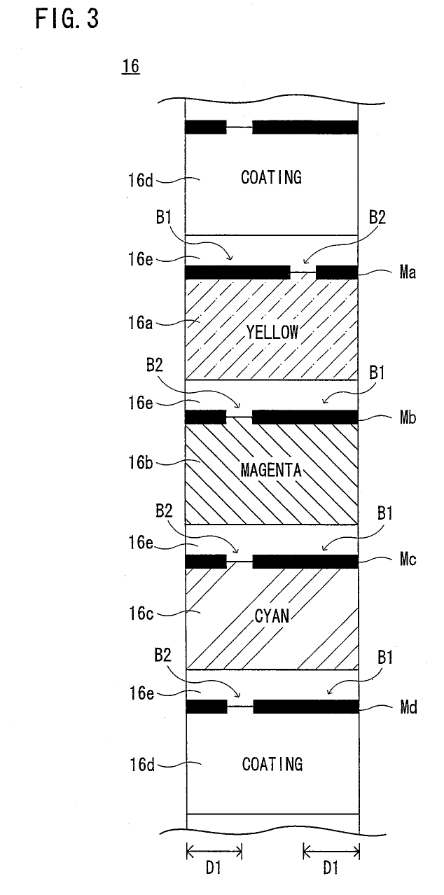

With referring to FIG. 3, a size of the transfer film 16 in a width direction is approximately accorded with a size of a printing paper (not shown) in a lateral direction. The transfer film 16 is coated with dye or wax such as yellow, magenta, cyan, or a coating. An area 16a coated with the dye of yellow is defined as a “yellow area”, an area 16b coated with the dye of magenta is defined as a “magenta area”, an area 16c coated with the dye of cyan is defined as a “cyan area”, and an area 16d coated with the coating is defined as a “coating area”. The areas 16a to 16d are formed at a predetermined interval in the length direction. Therefore, a size of each of the areas 16a to 16d is approximately the same as the size of the printing paper. It is noted that an area 16e coated with no dyes and coating 16e is defined as an “invalid area”.

A marker Ma is formed on the boundary between the invalid area 16e and the yellow area 16a, a marker Mb is formed on the boundary between the invalid area 16e and the magenta area 16b, a marker Mc is formed on the boundary between the invalid area 16e and the cyan area 16c, and a marker Md is formed on the boundary between the invalid area 16e and the coating area 16d. Each of the markers Ma to Md consists of a colored portion B1 and a colorless portion B2 that extend in the form of the belt in the width direction of the transfer film 16. More specifically, the marker Ma has the colorless portion B2 located at a distance D1 from one end in the width direction of the transfer film 16, and each of the markers Mb to Md has the colorless portion B2 located at the distance D1 from the other end in the width direction of the transfer film 16.

It is noted that each of the yellow area 16a, the magenta area 16b, and the cyan area 16c is transparent and colored, and each of the coating area 16d and the invalid area 16e is transparent and colorless. Furthermore, the colored portions of markers Ma to Md are opaque and black.

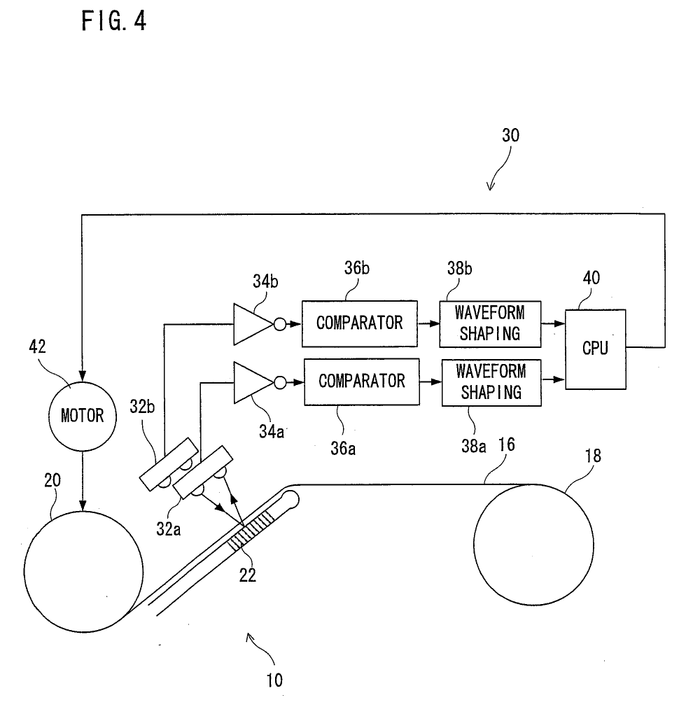

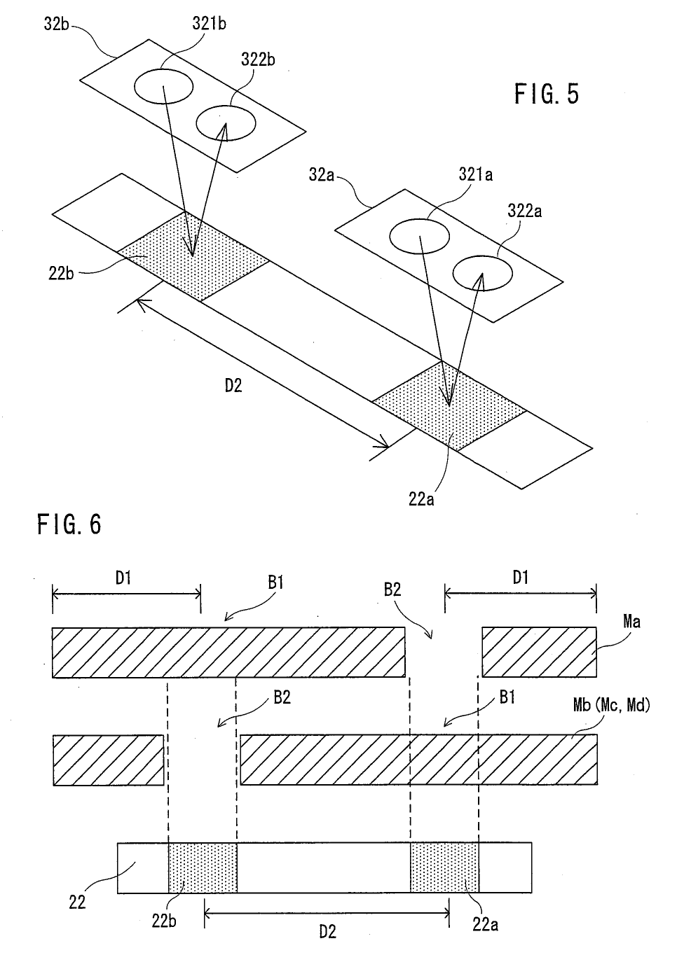

With referring to FIG. 4 and FIG. 5, when the transfer film cassette 10 of this embodiment is attached to a printer 30, optical sensors 32a and 32b provided in the printer 30 are opposed to the reflecting surface 22 with the transfer film 16 interposed. Describing in detail, the optical sensors 32a and 32b are spaced at a distance D2 with each other in the width direction of the transfer film 16, and rough surfaces (embossing surfaces) 22a and 22b are formed by a rough surface processing (embossing) on the reflecting surface 22 at the distance D2 with each other. Thus, the optical sensors 32a and 32b are respectively opposed to the rough surfaces 22a and 22b with the transfer film 16 interposed.

With referring to FIG. 6, when the marker Ma formed on the transfer film 16 is reached to the reflecting surface 22, the colorless portion B2 is interposed between the optical sensor 32a and the rough surface 22a, and the colored portion B1 is interposed between the optical sensor 32b and the rough surface 22b. When the marker Mb, Mc or Md formed on the transfer film 16 reaches to the reflecting surface 22, the colored portion B1 is interposed between the optical sensor 32a and the rough surface 22a, and the colorless portion B2 is interposed between the optical sensor 32b and the rough surface 22b.

The optical sensor 32a has a light emitting element 321a and a light receiving element 322a, and the optical sensor 32b has a light emitting element 321b and a light receiving element 322b. When the reflecting surface 22 is covered with any one of the areas 16a to 16e, light beams emitted from the light emitting elements 321a and 322a are respectively illuminated to the rough surfaces 22a and 22b through the transfer film 16. The light beams reflected by the rough surfaces 22a and 22b are incident to the light receiving elements 32a and 32b passing through the transfer film 16.

On the contrary thereto, when the reflecting surface 22 is covered with the marker Ma, a light beam emitted from the light emitting element 321a is reflected by the rough surface 22a to be incident to the light receiving element 322a while a light beam emitted from the light emitting element 321b is cut off by the colored portion B1. Furthermore, when the reflecting surface 22 is covered with the marker Mb, Mc or Md, a light beam emitted from the light emitting element 321b is reflected by the rough surface 22b to be incident to the light receiving element 322b while a light beam illuminated from the light emitting element 321a is cut off by the colored portion B1.

Returning to FIG. 4, each of the light receiving elements 322a and 322b outputs a detection signal having a level corresponding to the incident light amount. An inverting amplifier 34a inverts the detection signal from the light receiving element 322a and amplifies the inverted detection signal. An inverting amplifier 34b also inverts the detection signal from the light receiving element 322b and amplifies the inverted detection signal. A comparator 36a compares the level of the amplified signal output from the inverting amplifier 34a with a threshold value, and a comparator 36b compares the level of the amplified signal output from the inverting amplifier 34b with the threshold value. If the level of the amplified signal is larger than the threshold value, “H” is obtained as a comparison result, and if the level of the amplified signal is equal to or less than the threshold value, “L” is obtained as a comparison result. Such a comparing processing is executed in response to a clock, and the comparison result is output from each of the comparators 36a and 36b during the half of the clock cycle.

A waveform shaping circuit 38a raises an output level when the comparator 36a has successively output the comparison result indicating “H” for six times, and reduces the output level when the comparator 36a has successively output the comparison result indicating “L” for six times. The waveform shaping circuit 38b also raises an output level when the comparator 36b has successively output the comparison result indicating “H” for six times, and reduces the output level when the comparator 36b has successively output the comparison result indicating “L” for six times.

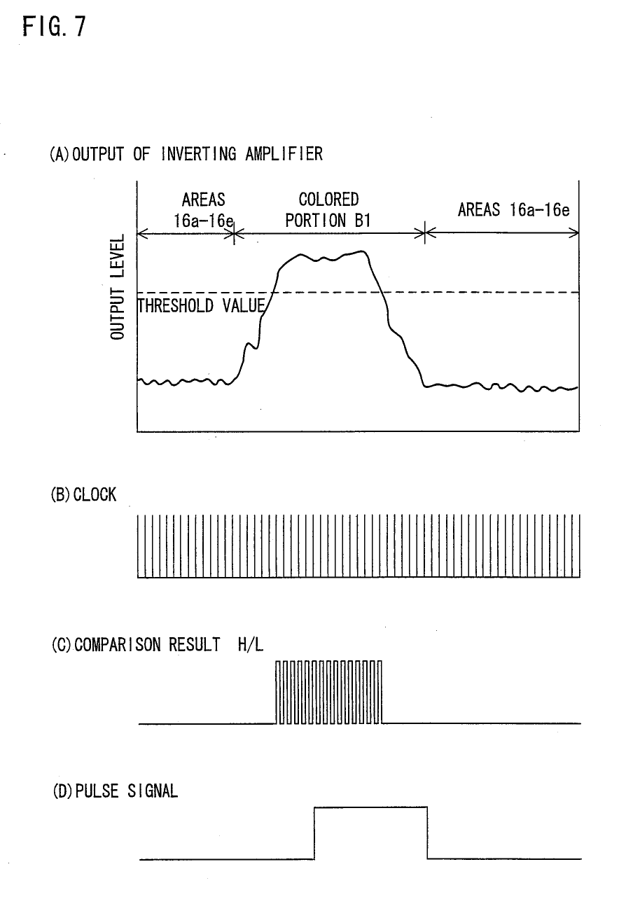

The level of the amplified signal output from the inverting amplifier 34a or 34b is changed as shown in FIG. 7(A) around the time when the rough surface 22a or 22b is covered with the colored portion B1. The comparison result of the comparator 36a or 36b is changed as shown in FIG. 7(C) in response to the clock shown in FIG. 7(B). The waveform shaping circuit 38a or 38b outputs a pulse signal shown in FIG. 7(D) on the basis of the comparison result in FIG. 7(C).

The CPU 40 controls a motor 42 for rotating the take-up spool 20 on the basis of the level of the pulse signals output from the waveform shaping circuits 38a and 38b. That is, when the waveform shaping circuits 38a and 38b respectively output a high level signal and a low level signal, the CPU 38 stops the motor 42, regarding that the head of the yellow area 16a shown in FIG. 3 has reached the reflecting surface 22.

After completion of printing with the yellow area 16a, the CPU 38 restarts to drive the motor 40. When the waveform shaping circuits 38a and 38b respectively output the high level signal and the low level signal, the CPU 38 stops the motor 40, regarding that the head of the magenta area 16b shown in FIG. 3 has reached the reflecting surface 22.

After completion of printing with the magenta area 16b, the CPU 38 restarts to drive the motor 40. When the waveform shaping circuits 38a and 38b respectively output the high level signal and the low level signal once again, the CPU 38 stops the motor 40, regarding that the head of the cyan area 16c shown in FIG. 3 has reached the reflecting surface 22.

After completion of printing with the cyan area 16c, the CPU 38 restarts to drive the motor 40. Then, when the waveform shaping circuits 38a and 38b respectively output the high level signal and the low level signal, the CPU 38 stops the motor 40, regarding that the head of the coating area 16d shown in FIG. 3 has reached the reflecting surface 22.

After completion of printing a sheet of printing paper, the CPU 38 sets a successive sheet of printing paper and executes a rotating control of the motor once again as described above.

As can be understood from the above-description, the marks Ma to Md are formed on the surface of the transfer film 16. When the transfer film cassette 10 is loaded in the printer 30, the marks Ma to Md are detected by the optical sensors 32a and 32b provided on the printer 30. Herein, the rough surface 22a is formed at an opposed position to the optical sensor 32a with the transfer film 16 interposed. Similarly, the rough surface 22b is formed at an opposed position to the optical sensor 32b with the transfer film 16 interposed. A reflectance ratio of the light beam at the rough surfaces 22a or 22b is smaller than that of an evaporated film and a plating film. Thus, the change in the amount of the reflected light due to a slack of the transfer film 16 or a fluctuation of angle of the incident light onto the rough surface 22a or 22b is reduced, and it is possible to perform precise positioning of the transfer film 16 utilizing the marks.

Although the present invention has been described and illustrated in detail, it is clearly understood that the same is by way of illustration and example only and is not to be taken by way of limitation, the spirit and scope of the present invention being limited only by the terms of the appended claims.

1. A transfer film cassette to be attached to a printer provided with an optical sensor, comprising:
a transfer film having a mark to be detected by said optical sensor; and
a case having a surface which causes diffuse reflection at an opposed position to said optical sensor with said transfer film interposed when being attached to said printer.

2. A transfer film cassette according to claim 1, wherein said optical sensor detects a light that is reflected by said surface and passed through said transfer film.

3. A transfer film cassette according to claim 1, wherein a front of said mark in a conveying direction of said transfer film is transparent, and said mark is opaque.

4. A transfer film cassette according to claim 1, further comprising:
a take-up spool for taking up said transfer film; and
a supply spool for supplying said transfer film.

5. A transfer film cassette according to claim 1, wherein said surface is a rough surface.
